(19) United States
(12) Patent Application Publication
(10) Pub. No.: US 2026/0159189 A1
(43) Pub. Date: Jun. 11, 2026

(54) A PRODUCT TRANSPORTATION VEHICLE, SYSTEM AND METHOD

(71) Applicants: MIGROS TICARET A.S., ISTANBUL (TR); HERGELE TEKNOLOJI ANONIM SIRKETI, ISTANBUL (TR)

(72) Inventors: Aysegul OZKAVUKCU, ISTANBUL (TR); Bulent KUNTAY, ISTANBUL (TR); Ibrahim OGUZ, ISTANBUL (TR); Esat GUN, ISTANBUL (TR); Ecem OGUZ, ISTANBUL (TR); Abdullah ERTUG, ISTANBUL (TR); Bugay CAGLAR, ISTANBUL (TR); Lal POLATER, ISTANBUL (TR); Sema Burce PAZARLI, ISTANBUL (TR)

(73) Assignees: MIGROS TICARET A.S., ISTANBUL (TR); BUGIWORKS TEKNOLOJI SANAYI IC VE DIS TICARET LIMITED SIRKETI, ISTANBUL (TR)

(21) Appl. No.: 18/704,162

(22) PCT Filed: Oct. 26, 2022
(86) PCT No.: PCT/TR2022/051184

§ 371 Date: Apr. 24, 2024

(30) Foreign Application Priority Data
Oct. 26, 2022 (TR) 2021/016702

(51) Int. Cl. B62J 43/10; B62J 50/22; B62K 11/02; B62K 21/12; B62K 25/00; B62K 27/12; G06K 7/10; G06K 7/14; G06Q 10/087; G07C 5/00; H04M 1/72412

(52) U.S. Cl. CPC B62J 43/10; B62J 50/22; B62K 11/02; B62K 21/12; B62K 25/00; B62K 27/12; G06Q 10/087; G07C 5/008; H04M 1/72412; G06K 2007/10524; G06K 7/1413

(57) ABSTRACT

The present invention relates to an electric product transportation vehicle for transporting products from one place to another, and a product transportation system and method for managing the product transportation process.

### TECHNICAL FIELD

The present invention relates to an electric product transportation vehicle for transporting products from one place to another, and a product transportation system and method for managing the product transportation process.

### BACKGROUND OF THE INVENTION

Today, product transportation vehicles and systems are used extensively for distribution centres in every sector where production takes place. In particular, for the manufacturing companies with large warehouse areas where their products are stored, there is a great need for auxiliary product transportation vehicles that will enable the products to be transported from one warehouse to another warehouse or directly to the places where the sales of such products are carried out, in the easiest and fastest way.

Forklifts, pallet trucks or electric pallet trucks are used in order to transport products from one place to another in the state of the art. Forklift trucks which are used extensively in product transportation take up a lot of space in warehouses, whereas pallet trucks require a lot of manpower and can cause occupational accidents or occupational diseases. Manual pallet trucks use manpower as a resource, however this does not allow the speed of the processes to exceed a certain level. A plurality of stores can be collected on a single pallet truck, however there is no infrastructure for the separation of stores. Electric pallet trucks, which are another transportation vehicle used in product transportation, are produced at very high cost and their product transportation capacity is quite low. The areas of use of electric pallet trucks can be defined as high capacity transportation. Although high-volume and weight transportation is carried out in warehouses and distribution centers, the use of electric pallet trucks for lower weights is inefficient.

For this reason, considering the studies and deficiencies included in the state of the art, it is understood that in order to make the goods collection processes more efficient in distribution centers, there is a need for a product transportation vehicle and system which is ergonomic; has high battery power and product transportation capacity; is long-lasting, low-cost and can transport more products in a shorter period of time; minimizes manpower; is functional, customizable and upgradable. The Chinese utility model document no. CN204567910U, an application included in the state of the art, discloses a system and method for transporting goods in warehouses by using electric scooter technology. The said invention discloses a commodity circulation warehouse of special use electronic folding car that carries cargo wherein the handlebar sub-assembly, front wheel sub-assembly, rear wheel sub-assembly, lifting saddle sub-assembly, drive motor sub-assembly and storage battery spare are formed, still including the draw-bar box subassembly. The disclosed invention ensures that, through the unique draw-bar box, the sub-assembly design enables convenient transportation of materials such as a portable draw-bar box for a foldable electric scooter in a warehouse; makes things convenient for the transport of small-size articles; increases the efficiency greatly at the same time; wherein the design waits the department of each folding hinge for whole car conveniently folding of the whole trolley, and it is simple and efficient to handle; which guarantees under the prerequisite safe by bike and reduces the volume after folding; and the tow-bar box allows the folding of the whole trolley in a portable way.

### SUMMARY OF THE INVENTION

The objective of the present invention is to realize an electric product transportation vehicle which enables products to be transported from one place to another and includes areas where products will be placed and electronic equipment for managing the product transportation processes on thereof.

Another objective of the present invention is to realize an electric product transportation vehicle which has a portable and replaceable battery system that enables transportation between a plurality of warehouse locations at a time.

Another objective of the present invention is to realize an electric product transportation vehicle which can be integrated into product transportation vehicles such as cranes, forklifts, hoists and conveyors and can be used as an industrial transportation crate.

Another objective of the present invention is to realize an electric product transportation vehicle which can move semi-autonomously, without a driver and transport products by means of the electronic equipment located thereon.

Another objective of the present invention is to realize an electric product transportation vehicle to which at least one trailer can be attached for transporting more products.

Another objective of the present invention is to realize an electric product transportation vehicle which enables the electronic equipment located thereon to be charged.

Another objective of the present invention is to realize an electric product transportation vehicle which includes anti-collision distance sensors on thereof and is capable of automatic braking when a collision signal is received.

Another objective of the present invention is to realize a product transportation system and method for managing the process of transporting products from one place to another.

Another objective of the present invention is to realize a product transportation system and method which enables management of failure conditions by obtaining the data related to a product transportation vehicle during a product transportation process.

### DETAILED DESCRIPTION OF THE INVENTION

“A Product Transportation Vehicle, System and Method” realized to fulfil the objectives of the present invention is shown in the figures attached, in which:

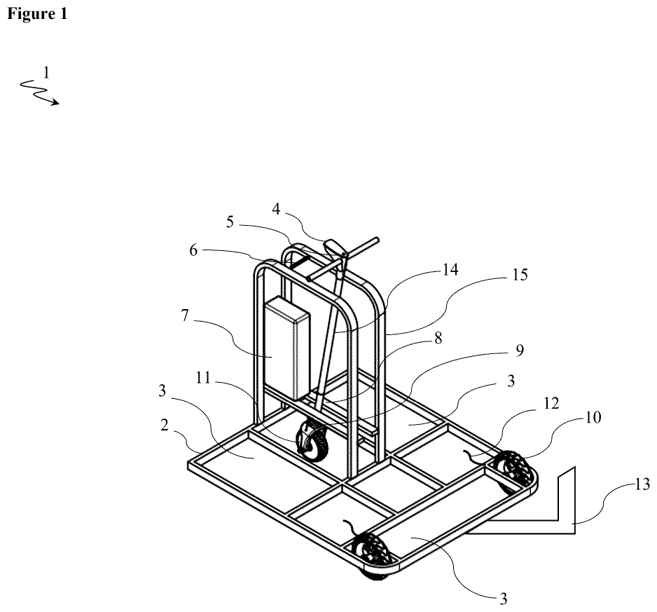

FIG. 1 is a perspective view of the inventive product transportation vehicle.

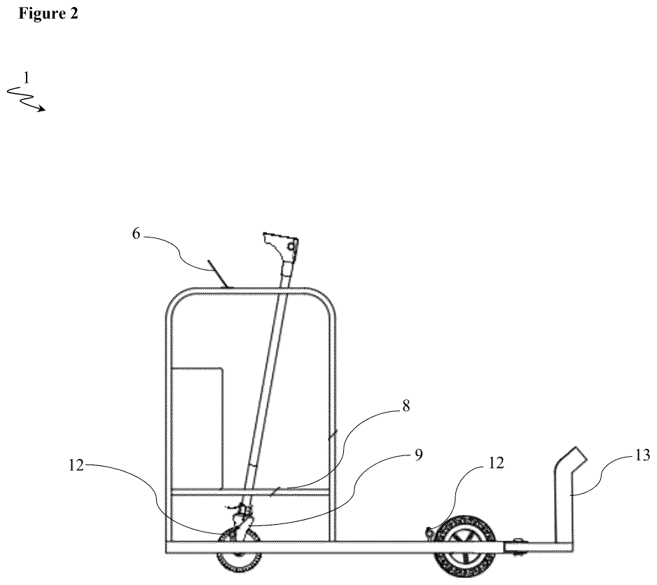

FIG. 2 is a side view of the inventive product transportation vehicle.

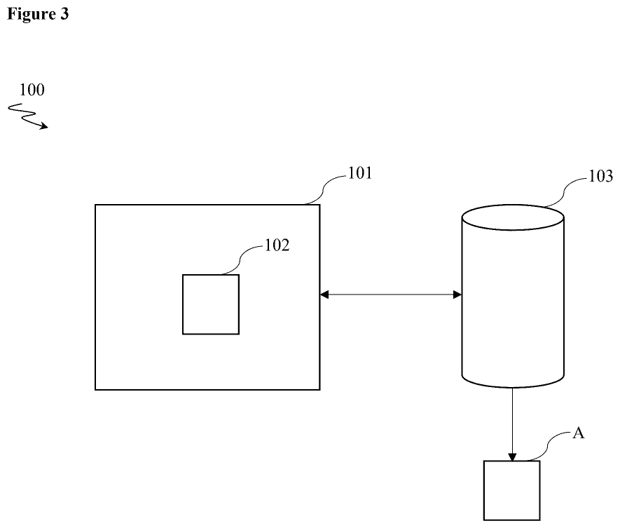

FIG. 3 is a schematic view of the inventive product transportation system.

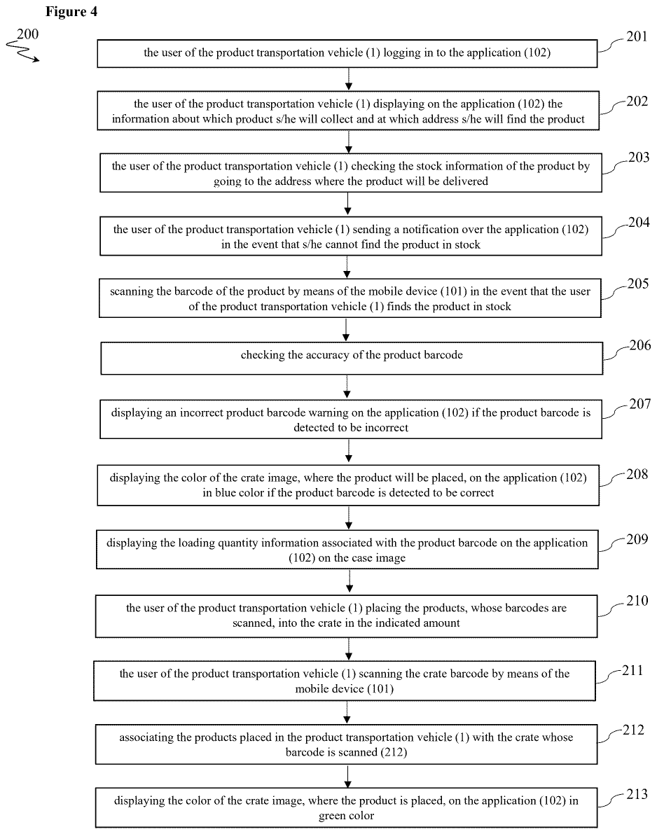

FIG. 4 is a flow chart of the inventive product transportation method.

The components illustrated in the figure are individually numbered, where the numbers refer to the following:
1. Product transportation vehicle
2. Chassis
3. Product placement compartment
4. Screen
5. Control pedal
6. Mobile device integration unit
7. Power unit
8. Handlebar
9. Damper
10. Wheel
11. Motor
12. Connecting hook
13. Towing apparatus
14. Connecting tube
15. Railing
100. Product transportation system
101. Mobile device
102. Application
103. Server
A. Electronic device
200. Product transportation method

The inventive product transportation vehicle (1) for transporting products from one place to another comprises:
a chassis (2) which carries all parts belonging to and being connected to the vehicle;
at least one product placement compartment (3) which is located on the chassis (2) and whereon the products are placed directly and/or within crates;
at least one screen (4) whereby vehicle-related information such as vehicle speed, charging information and warning notifications are displayed;
at least one control pedal (5) which enables to control acceleration and deceleration of a vehicle;
at least one mobile device integration unit (6) which enables a device such as a mobile phone or tablet computer to be integrated;
at least one power unit (7) wherein a battery system supplying power to the vehicle is included;
at least one handlebar (8) which enables the vehicle to maneuver;
at least one damper (9) which enables to attenuate the intensity and impact of shocks that occur during driving;
at least one wheel (10) which enables the vehicle to move by rotating around an axis located in its center;
at least one motor (11) which enables the vehicle to move by converting the energy provided by the power unit (7) into mechanical energy and which is embedded inside the wheel (10);
at least one connecting hook (12) which enables the vehicle to be raised upon being loaded to lifting vehicles in the form of a crane;
at least one towing apparatus (13) which enables transportation crates in the form of trailers to be attached to the rear of the vehicle;
at least one connecting tube (14) which interconnects the control pedal (5) and the front wheel (10); and
at least one railing (15) which ensures the vehicle balance by being positioned on both sides of the connecting tube (14) and into which the power unit is integrated.

The inventive product transportation vehicle (1) is a vehicle in the form of scooter which has at least one product placement compartment (3) enabling the products to be placed directly or within crates and also enabling the products to be transported from one place to another. The said product transportation vehicle (1) has the main chassis (2) which carries all of its parts and consists of tubular profiles, a connecting tube (14) which carries the handlebar (8) on the main chassis and provides the connection of the control pedal (5) with the front wheel (10) of the vehicle, handles which are positioned on the connecting tube (14) and enable the user to operate the vehicle, a railing (15) which enables the vehicle to be balanced by being positioned on both sides of the connecting tube (14), and lightings in the form of headlights at the front and rear. In one embodiment of the invention, the main chassis (2) of the product transportation vehicle (1) is manufactured from tubular profiles. In a preferred embodiment of the invention, the product transportation vehicle (1) is an electric vehicle having a replaceable battery system. The product transportation vehicle (1) can be guided and operated by a user or semi-autonomously. In one embodiment of the invention, the product transportation vehicle (1) has a compartment on which the user can stand, which is manufactured from expanded sheet metal by laser cutting and fixed to the chassis (2) by mig-mag welding method. The parts constituting the said product transportation vehicle (1) are manufactured from materials that can be recycled by using advanced recycling technology.

The product transportation vehicle (1) is configured to communicate with an electronic device (A) in the form of smart glasses which enables to show the location of products in the collection areas to users visually and to guide the users by using any remote and/or near field communication protocol included in the state of the art. In the preferred embodiment of the invention, the product transportation vehicle (1) is configured to communicate and realize data exchange with an electronic device (A) in the form of smart glasses by using a near-field communication protocol in the form of Bluetooth.

The product transportation vehicle (1) has at least one product placement compartment (3) wherein at least the product transportation crates are placed and which is positioned two on the right and left sides at the front and one at the rear on the main chassis (2) in order to ensure balance.

The said product transportation vehicle (1) has at least one screen (4) which is located on the connecting tube (14), has a communication unit that can communicate with remote servers by means of any remote communication protocol and enables vehicle-related information such as vehicle speed, charging information, user-related information such as health and performance information and warning notifications to be displayed.

The product transportation vehicle (1) has at least one control pedal (5) which is positioned on the connecting tube (14) and enables the acceleration and deceleration of the vehicle to be controlled. The said product transportation vehicle (1) has control pedals (5) in the form of at least one accelerator pedal for controlling the acceleration of the vehicle and at least one brake pedal for controlling the deceleration of the vehicle.

The product transportation vehicle (1) has at least one mobile device integration unit (6) which is positioned on the railing (15) connected to the main chassis (2) and wherein a mobile device (101) such as a mobile phone, tablet computer can be integrated to establish connection with the product transportation system (100). The mobile device integration unit (6) has a compartment wherein any mobile device (101) can be placed, and a charging cable outlet whereby the said mobile device (101) can be charged and that is connected to the power unit (7).

The product transportation vehicle (1) has at least one power unit (7) which is located on the railing (15) connected to the main chassis (2) and contains the battery system that supplies power to the vehicle. The said power unit (7) is a battery box wherein batteries are placed, electronic components are included and which has cable outputs connected to the mobile device integration unit (6).

The product transportation vehicle (1) has at least one handlebar (8) which is located on the connecting tube (14) and enables the vehicle to maneuver. In the preferred embodiment of the invention, the product transportation vehicle (1) has the ability to move backwards by rotating the handlebar (8) 180 degrees.

The product transportation vehicle (1) has at least one damper (9) which is located on the connecting tube (14) and provides attenuation of the intensity and impact of the shocks that occur during driving.

The product transportation vehicle (1) has wheels (10) which are located on the main chassis (2) and enable the vehicle to move by rotating around an axis located in its center and have a disc brake system. In the preferred embodiment of the invention, the said wheels (10) are positioned on the main chassis (2), one at the front in the center and two at the rear on the sides of the chassis (2).

The product transportation vehicle (1) has at least one motor (11) that enables the vehicle to move by converting the energy provided by the power unit (7) into mechanical energy. The said motor (11) is preferably a high-torque motor (11) which has a planetary gear system and is embedded in any of the wheels (10).

The product transportation vehicle (1) has at least one connecting hook (12) which is located on the main chassis (2) and enables the vehicle to be raised upon being loaded to lifting vehicles in the form of a crane. In the preferred embodiment of the invention, the said connecting hooks (12) are positioned on the chassis such that one at the front and one at the rear in order to ensure the balance of the vehicle while being raised.

The product transportation vehicle (1) has at least one towing apparatus (13) which is located on the main chassis (2) and enables transportation crates in the form of trailers to be attached to the rear of the vehicle.

The product transportation vehicle (1) has at least one connecting tube (14) which interconnects the control pedal (5) and the front wheel (10).

The product transportation vehicle (1) has at least one railing (15) which enables the vehicle balance by being positioned on both sides of the connecting tube (14) on the main chassis (2) and into which the power unit is integrated.

A product transportation system (100) for managing the product transportation process when transporting products from one place to another comprises:
at least one mobile device (101) which is integrated into the mobile device integration unit (6) located on the product transportation vehicle (1) and is configured to communicate with remote servers by using any remote communication protocol;
at least one application (102) which is run on the mobile device (101) and configured to manage the product transportation process; and
at least one server (103) which can communicate with the mobile device (101) by using any remote communication protocol, wherein product collection information are recorded and which is configured to manage the product stock status in accordance with the processes carried out over the application (102).

The mobile device (101) included in the inventive product transportation system (100) is a device such as a mobile phone, tablet computer that can be integrated into the mobile device integration unit (6) located on the product transportation vehicle (1). The said mobile device (101) is configured to communicate with the mobile device integration unit (6) located on the product transportation vehicle (1), in a wired or wireless way. In the preferred embodiment of the invention, the mobile device (101) is configured to run at least one application (102) configured to enable the execution and management of product transportation processes thereon. The said mobile device (101) is configured to communicate and realize data exchange with the server (103) over any remote communication protocol. In the preferred embodiment of the invention, the mobile device (101) has a speaker for audio output, at least one camera capable of taking images and a touch screen. The said mobile device (101) is configured to enable the scanning of barcodes of products by means of its camera. In the preferred embodiment of the invention, the mobile device (101) is a device such as a barcode scanner capable of communicating with the product transportation device (1) via Bluetooth, which is a wireless connection method.

The application (102) included in the inventive product transportation system (100) is run on the mobile device (101) and configured to enable at least product transportation processes to be carried out. The said application (102) is configured to provide at least one interface adapted to allow users to log in with a cookie identified to them in the form of a username and password. The application (102) is configured to provide at least one interface adapted to allow users to enter a unique identification information, that is a distinguishing information related to the product transportation vehicles (1), in order to find out by which product transportation vehicle (1) they will be transporting products. The said application (102) is configured to provide at least one interface adapted to allow users to enter the unique identification information of the product transportation vehicle (1) and to make selection by entering the group type information and the order date. The application (102) is also configured to allow users to select the charging group after entering the group type information and the order date and to view which products at which addresses they will receive according to the selected charging group. The application (102) is configured to provide at least one interface adapted to allow users to view which products to collect, the quantities of the products, from where to collect the products, and to which addresses to deliver the products. The application (102) is configured to display information about the products and the crates wherein the products are located. The application (102) is configured to provide at least one interface adapted to allow users to trigger the camera on the mobile device (101) to scan any product barcode, and to scan the product barcode. The said application (102) is configured to ensure that the crates containing the products are displayed with specifically coded colors related to the processes performed on the crates. In the event that users scan an incorrect product barcode, the application (102) is configured to display a warning notification that a wrong product barcode has been scanned. The said application (102) is configured to display each crate containing the products, and the information of order and loading quantity for each crate on the crate visuals. In the preferred embodiment of the invention, the application (102) is configured to provide at least one interface adapted to allow users to trigger the camera on a mobile device (101) in order to scan crate barcodes. The said application (102) is configured to display an interface whereby the quantity of product to be received and the quantity of the product loaded are displayed after the user places the product crates on the product transportation vehicle (1). The application (102) is further configured to enable the user to confirm the loading process or manually enter the quantity of the product loaded on the interface that displays the quantity of product to be received and the quantity of the product loaded after the user places the product crates on the product transportation vehicle (1).

The server (103) included in the inventive product transportation system (100) is configured to communicate with the mobile device (101) by using any remote communication protocol and to realize data exchange with the application (102) being run on the mobile device (101) over this communication established. The said server (103) is configured to manage the stock quantities in warehouses where products are stored and to update the product stocks during the product transportation process. The server (103) is configured to determine the warehouses where the product transportation vehicle (1) should go first and receive the products based on the identification number information and to present it to the users over the application (102). The server (103) is configured to ensure that the color codes of the product crates and the product stocks are updated as the users place the products in the crates to be placed in the product transportation vehicle (1). The server (103) is configured to transmit the updated case color code information and the product quantity information to the application (102). In the preferred embodiment of the invention, the server (103) is configured to communicate with an electronic device (A) in the form of a smart glasses which, by using any remote communication protocol, provides users with a visual indication of the location of the products in the collection areas and provides guidance to the users. The said server (103) is configured to ensure that the location information of the products are transmitted to the electronic device (A) by accessing the product information to be transported by the users of the product transportation vehicle (1), and the product locations are presented to the users in the form of a virtual environment whereby the product positions are displayed on an image of the environment where they are located. product transportation method (200) for managing the product transportation process when transporting products from one place to another comprises the steps of:
the user of the product transportation vehicle (1) logging in to the application (102) (201);

the user of the product transportation vehicle (1) displaying on the application (102) the information about which product s/he will collect and at which address s/he will find the product (202);
the user of the product transportation vehicle (1) checking the stock information of the product by going to the address where the product will be delivered (203);
the user of the product transportation vehicle (1) sending a notification over the application (102) in the event that s/he cannot find the product in stock (204);
scanning the barcode of the product by means of the mobile device (101) in the event that the user of the product transportation vehicle (1) finds the product in stock (205);
checking the accuracy of the product barcode (206);
displaying an incorrect product barcode warning on the application (102) if the product barcode is detected to be incorrect (207);
displaying the color of the crate image, where the product will be placed, on the application (102) in blue color if the product barcode is detected to be correct (208);
displaying the loading quantity information associated with the product barcode on the application (102) on the case image (209);
the user of the product transportation vehicle (1) placing the products, whose barcodes are scanned, into the crate in the indicated amount (210);
the user of the product transportation vehicle (1) scanning the crate barcode by means of the mobile device (101) (211);
associating the products placed in the product transportation vehicle (1) with the crate whose barcode is scanned (212); and
displaying the color of the crate image, where the product is placed, on the application (102) in green color (213).

### INDUSTRIAL APPLICABILITY OF THE INVENTION

The product transportation vehicle (1), the product transportation system (100) and the method (200) provided by the said invention can be used in all production and product/goods collection sectors and they enable product collection, warehouse change or store delivery processes to be made more efficient and ergonomic. In addition, the product transportation vehicle (1) has the capacity to transport products from multiple product storage areas to multiple locations at the same time without energy interruption thanks to its replaceable battery system. It is ensured that product transportation processes are managed and the correct products are delivered to the correct addresses by integrating the product transportation vehicle (1) with the product transportation system (100).

The inventive product transportation vehicle (1) has a main chassis (2) which consists of tubular profiles carrying all its parts. The product transportation vehicle (1) has a compartment on which the user can stand, which is manufactured from expanded sheet metal by laser cutting and fixed to the chassis (2) by mig-mag welding. The product transportation vehicle (1) also has at least one product placement compartment (3) wherein at least the product transportation crates are placed and which is positioned two on the right and left sides at the front and one at the rear on the main chassis (2) in order to ensure balance in the preferred embodiment of the invention. In the preferred embodiment of the invention, the power unit (7) included in the product transportation vehicle (1) is a battery box wherein batteries are placed, electronic components are included and which has cable outputs connected to the mobile device integration unit (6). The wheels (10) of the inventive product transportation vehicle (1) have a disc brake system and each of them is at least 8.5 inches in size. The product transportation vehicle (1) has at least one motor (11) which enables the vehicle to move by converting the energy provided by the power unit (7) into mechanical energy, and which is included in one of the wheels (10) of the vehicle (1) as embedded with a size of at least 6.5 inches and a power of at least 250 Watts. In the preferred embodiment of the invention, the connecting hooks (12)—which the product transportation vehicle (1) has and which enable the vehicle (1) to be raised upon being loaded onto lifting devices in the form of cranes—are positioned on the chassis, one at the front and one at the rear, in order to ensure the balance of the vehicle while being raised.

Within these basic concepts; it is possible to develop a wide variety of embodiments of the inventive “Product Transportation Vehicle (1), System (100) and Method (200)”; the invention cannot be limited to examples disclosed herein and it is essentially according to claims.

1. A product transportation vehicle (1) for transporting products from one place to another; comprising
a chassis (2) which carries all parts belonging to and being connected to the vehicle;
at least one control pedal (5) which enables to control acceleration and deceleration of a vehicle;
at least one power unit (7) wherein a battery system supplying power to the vehicle is included;
at least one handlebar (8) which enables the vehicle to maneuver;
at least one damper (9) which enables to attenuate the intensity and impact of shocks that occur during driving;
at least one wheel (10) which enables the vehicle to move by rotating around an axis located in its center;
at least one motor (11) which enables the vehicle to move by converting the energy provided by the power unit (7) into mechanical energy and which is embedded inside the wheel (10);
and characterized by
at least one product placement compartment (3) which is located on the chassis (2) and whereon the products are placed directly and/or within crates;
at least one screen (4) whereby vehicle-related information such as vehicle speed, charging information and warning notifications are displayed;
at least one mobile device integration unit (6) which enables a device such as a mobile phone or tablet computer to be integrated;
at least one connecting hook (12) which enables the vehicle to be raised upon being loaded to lifting vehicles in the form of a crane;
at least one towing apparatus (13) which enables transportation crates in the form of trailers to be attached to the rear of the vehicle;
at least one connecting tube (14) which interconnects the control pedal (5) and the front wheel (10); and
at least one railing (15) which ensures the vehicle balance by being positioned on both sides of the connecting tube (14) and into which the power unit is integrated.

2. (canceled)

3. A product transportation vehicle (1) according to claim 1; characterized by the main chassis (2) which carries all of its parts and consists of tubular profiles, at least one connecting tube (14) which carries the handlebar (8) on the main chassis and provides the connection of the control pedal (5) with the front wheel (10) of the vehicle, at least one handle which is positioned on the connecting tube (14) and enables the user to operate the vehicle, at least one railing (15) which enables the vehicle to be balanced by being positioned on both sides of the connecting tube (14), and lightings in the form of headlights at the front and rear.

4. (canceled)

5. A product transportation vehicle (1) according to claim 1; characterized by the characteristic to communicate with an electronic device in the form of smart glasses which enables to show the location of products in the collection areas to users visually and to guide the users by using any remote and/or near field communication protocol.

6. A product transportation vehicle (1) according to claim 5; characterized by the characteristic to communicate and realize data exchange with an electronic device in the form of smart glasses by using a near-field communication protocol in the form of Bluetooth.

7. (canceled)

8. A product transportation vehicle (1) according to claim 1; characterized by at least one screen (4) which is located on the connecting tube (14), has a communication unit that can communicate with remote servers by means of any remote communication protocol and enables vehicle-related information such as vehicle speed, charging information, user-related information such as health and performance information and warning notifications to be displayed.

9-22. (canceled)

23. A product transportation system (100) for managing the product transportation process when transporting products from one place to another; comprising
at least one mobile device (101) which is integrated into the mobile device integration unit (6) located on the product transportation vehicle (1) and is configured to communicate with remote servers by using any remote communication protocol;
and characterized by
at least one application (102) which is run on the mobile device (101) and configured to manage the product transportation process; and
at least one server (103) which can communicate with the mobile device (101) by using any remote communication protocol, wherein product collection information are recorded and which is configured to manage the product stock status in accordance with the processes carried out over the application (102).

24-26. (canceled)

27. A product transportation system (100) according to claim 23; characterized by the mobile device (101) which is configured to communicate and realize data exchange with the server (103) over any remote communication protocol.

28. A product transportation system (100) according to claim 23; characterized by the mobile device (101) that has a speaker for audio output, at least one camera capable of taking images and a touch screen.

29. A product transportation system (100) according to claim 23; characterized by the mobile device (101) which is configured to enable the scanning of barcodes of products by means of its a camera.

30-31. (canceled)

32. A product transportation system (100) according to claim 23; characterized by the application (102) which is configured to provide at least one interface adapted to allow users to log in with a cookie identified to them in the form of a username and password.

33. A product transportation system (100) according to claim 23; characterized by the application (102) which is configured to provide at least one interface adapted to allow users to enter a unique identification information, that is a distinguishing information for the product transportation vehicles (1), in order to find out by which product transportation vehicle (1) they will be transporting products.

34. A product transportation system (100) according to claim 23; characterized by the application (102) which is configured to provide at least one interface adapted to allow users to enter the unique identification information of the product transportation vehicle (1) and to make selections by entering the group type information and the order date.

35. A product transportation system (100) according to claim 23; characterized by the application (102) which is configured to allow users to select the charging group after entering the group type information and the order date and to view which products at which addresses they will receive according to the selected charging group.

36. A product transportation system (100) according to claim 23; characterized by the application (102) which is configured to provide at least one interface adapted to allow users to view which products to collect, the quantities of the products, from where to collect the products, and to which addresses to deliver the products.

37. (canceled)

38. A product transportation system (100) according to claim 23; characterized by the application (102) which is configured to provide at least one interface adapted to allow users to trigger the camera on the mobile device (101) to scan any product barcode, and to scan the product barcode or the crate barcode.

39. A product transportation system (100) according to claim 23; characterized by the application (102) which is configured to ensure that the crates containing the products are displayed with specifically coded colors related to the processes performed on the crates.

40. A product transportation system (100) according to claim 23; characterized by the application (102) which is configured to display a warning notification that a wrong product barcode has been scanned, in the event that users scan an incorrect product barcode.

41. A product transportation system (100) according to claim 23; characterized by the application (102) which is configured to display each crate containing the products, and the information of order and loading quantity for each crate on the crate visuals.

42. (canceled)

43. A product transportation system (100) according to claim 23; characterized by the application (102) which is configured to display an interface whereby the quantity of product to be received and the quantity of the product loaded are displayed after the user places the product crates on the product transportation vehicle (1).

44. A product transportation system (100) according to claim 23; characterized by the application (102) which is configured to enable the user to confirm the loading process or manually enter the quantity of the product loaded on the interface that displays the quantity of product to be received and the quantity of the product loaded after the user places the product crates on the product transportation vehicle (1).

45. (canceled)

46. A product transportation system (100) according to claim 23; characterized by the server (103) which is configured to manage the stock quantities in warehouses where products are stored and to update the product stocks during the product transportation process.

47. A product transportation system (100) according to claim 23; characterized by the server (103) which is configured to determine the warehouses where the product transportation vehicle (1) should go first and receive the products based on the identification number information and to present it to the users over the application (102).

48. A product transportation system (100) according claim 45; characterized by the server (103) which is configured to ensure that the color codes of the product crates and the product stocks are updated as the users place the products in the crates to be placed in the product transportation vehicle (1) and to transmit the updated case color code information and the product quantity information to the application (102).

49. (canceled)

50. A product transportation system (100) according to claim 23; characterized by the server (103) which configured to communicate with an electronic device (A) in the form of a smart glasses which, by using any remote communication protocol, provides users with a visual indication of the location of the products in the collection areas and provides guidance to the users.

51. A product transportation system (100) according to claim 23; characterized by the server (103) which is configured to ensure that the location information of the products are transmitted to the electronic device (A) by accessing the product information to be transported by the users of the product transportation vehicle (1), and the product locations are presented to the users in the form of a virtual environment whereby the product positions are displayed on an image of the environment where they are located.

52. A product transportation method (200) for managing the product transportation process when transporting products from one place to another; characterized by the steps of
the user of the product transportation vehicle (1) logging in to the application (102) (201);
the user of the product transportation vehicle (1) displaying on the application (102) the information about which product s/he will collect and at which address s/he will find the product (202);
the user of the product transportation vehicle (1) checking the stock information of the product by going to the address where the product will be delivered (203);
the user of the product transportation vehicle (1) sending a notification over the application (102) in the event that s/he cannot find the product in stock (204);
scanning the barcode of the product by means of the mobile device (101) in the event that the user of the product transportation vehicle (1) finds the product in stock (205);
checking the accuracy of the product barcode (206);
displaying an incorrect product barcode warning on the application (102) if the product barcode is detected to be incorrect (207);
displaying the color of the crate image, where the product will be placed, on the application (102) in blue color if the product barcode is detected to be correct (208);
displaying the loading quantity information associated with the product barcode on the application (102) on the case image (209);
the user of the product transportation vehicle (1) placing the products, whose barcodes are scanned, into the crate in the indicated amount (210);
the user of the product transportation vehicle (1) scanning the crate barcode by means of the mobile device (101) (211);
associating the products placed in the product transportation vehicle (1) with the crate whose barcode is scanned (212); and
displaying the color of the crate image, where the product is placed, on the application (102) in green color (213).
